(19) United States
(12) Patent Application Publication
(10) Pub. No.: US 2013/0126078 A1
(43) Pub. Date: May 23, 2013

(54) METHOD OF FORMING AN ARTICLE ATTACHABLE TO AN EXTERIOR SURFACE OF A VEHICLE

(71) Applicants: Catherine A. Ostrander, Grand Blanc, MI (US); Kitty L. Gong, Macomb, MI (US); Charles K. Buehler, Lansing, MI (US); Chris A. Oberlitner, Shelby Township, MI (US)

(72) Inventors: Catherine A. Ostrander, Grand Blanc, MI (US); Kitty L. Gong, Macomb, MI (US); Charles K. Buehler, Lansing, MI (US); Chris A. Oberlitner, Shelby Township, MI (US)

(73) Assignee: GM GLOBAL TECHNOLOGY OPERATIONS LLC, Detroit, MI (US)

(21) Appl. No.: 13/303,729

(22) Filed: Nov. 23, 2011

(51) Int. Cl. B29C 51/14

(52) U.S. Cl. 156/245

(57) ABSTRACT

A method of forming an article attachable to an exterior surface of a vehicle includes heating a thermoplastic system to form a preform. The preform has a first surface having an initial distinctness of image and an initial gloss, and a second surface spaced opposite from the first. The method also includes disposing the preform between a mold surface and a pressure surface spaced apart from the mold surface so that the first surface faces the mold surface, and the second surface faces the pressure surface. Further, the first surface and the mold surface define a first cavity therebetween, and the second surface and the pressure surface define a second cavity therebetween. After disposing, the method includes conforming the first surface to the mold surface to thereby form the article, wherein the article has the initial distinctness of image and the initial gloss.

### TECHNICAL FIELD

The present disclosure generally relates to a method of forming an article attachable to an exterior surface of a vehicle.

### BACKGROUND

Vehicles often include distinctive badging, such as emblems, to denote a brand and/or manufacturer of the vehicle. Such emblems are generally designed to convey a positive and easily-recognizable association between the vehicle and the manufacturer of the vehicle, and are therefore often attached to visible exterior surfaces of the vehicle, e.g., front grilles, rear liftgates and trunks, and/or wheel covers. Any defect or degradation of the emblem may diminish the perceived quality of the vehicle and/or tarnish the reputation of the vehicle manufacturer.

### SUMMARY

A method of forming an article attachable to an exterior surface of a vehicle includes heating a thermoplastic system to form a preform. The thermoplastic system includes a substrate and a cured film formed from a coating composition and joined to the substrate. Further, the preform has a first surface having an initial distinctness of image and an initial gloss, and a second surface spaced opposite from the first surface. The method also includes disposing the preform between a mold surface and a pressure surface spaced apart from the mold surface so that the first surface faces the mold surface, and the second surface faces the pressure surface. The first surface and the mold surface define a first cavity therebetween, and the second surface and the pressure surface define a second cavity therebetween. After disposing, the method includes conforming the first surface to the mold surface to thereby form the article, wherein the article has the initial distinctness of image and the initial gloss.

In one embodiment, the first surface corresponds to the cured film, and the mold surface defines a plurality of recessions therein. Further, the first cavity and the second cavity are not disposed in fluid communication. In addition, the article includes a plurality of protrusions thereon each corresponding to a respective one of the plurality of recessions. For this embodiment, after disposing the preform between the mold surface and the pressure surface, the method includes cooling the mold surface. Subsequently, after cooling, the method includes conforming the first surface to the mold surface to thereby form the article, wherein the article has the initial distinctness of image and the initial gloss.

In another embodiment, after disposing, the method includes cooling the mold surface to a temperature of less than or equal to about 38° C. In addition, conforming includes concurrently evacuating the first cavity and pressurizing the second cavity. Evacuating includes exposing the first surface to a vacuum of from about 33 KPa to about 75 KPa within the first cavity for a duration of from about 5 seconds to about 60 seconds, and pressurizing includes applying a compressed gas having a temperature of less than or equal to about 21° C. at a pressure of from about 345 KPa to about 1,035 KPa to the second surface for a duration of from about 5 seconds to about 40 seconds.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

### BRIEF DESCRIPTION OF THE DRAWINGS

FIG. 1 is a schematic illustration of an elevational view of an article attached to an exterior surface of a vehicle;

FIG. 2 is a schematic flowchart of a method of forming the article of FIG. 1;

FIG. 3 is a schematic cross-sectional illustration of a thermoplastic system for forming the article of FIG. 1;

FIG. 4 is a schematic cross-sectional illustration of a preform formed from the thermoplastic system of FIG. 3;

FIG. 5 is a schematic illustration of an elevational view of the article of FIG. 1 formed from the preform of FIG. 4 before attachment to the exterior of the vehicle of FIG. 1;

FIG. 5A is a schematic cross-sectional illustration of the article of FIG. 5, taken along section lines 5A-5A;

FIG. 6 is a schematic illustration of a side view of the thermoplastic system of FIG. 3 disposed between two heating stations;

FIG. 7 is a schematic partially cross-sectional illustration the preform of FIG. 4 disposed between a mold surface and a pressure surface of a device configured for thermoforming;

FIG. 8 is a schematic fragmentary illustration of a top view of a portion of the mold surface of FIG. 7, wherein the mold surface defines a plurality of recessions therein; and

FIG. 9 is a schematic partially cross-sectional illustration of the preform of FIG. 4 conformed to the mold surface of FIG. 7.

### DETAILED DESCRIPTION

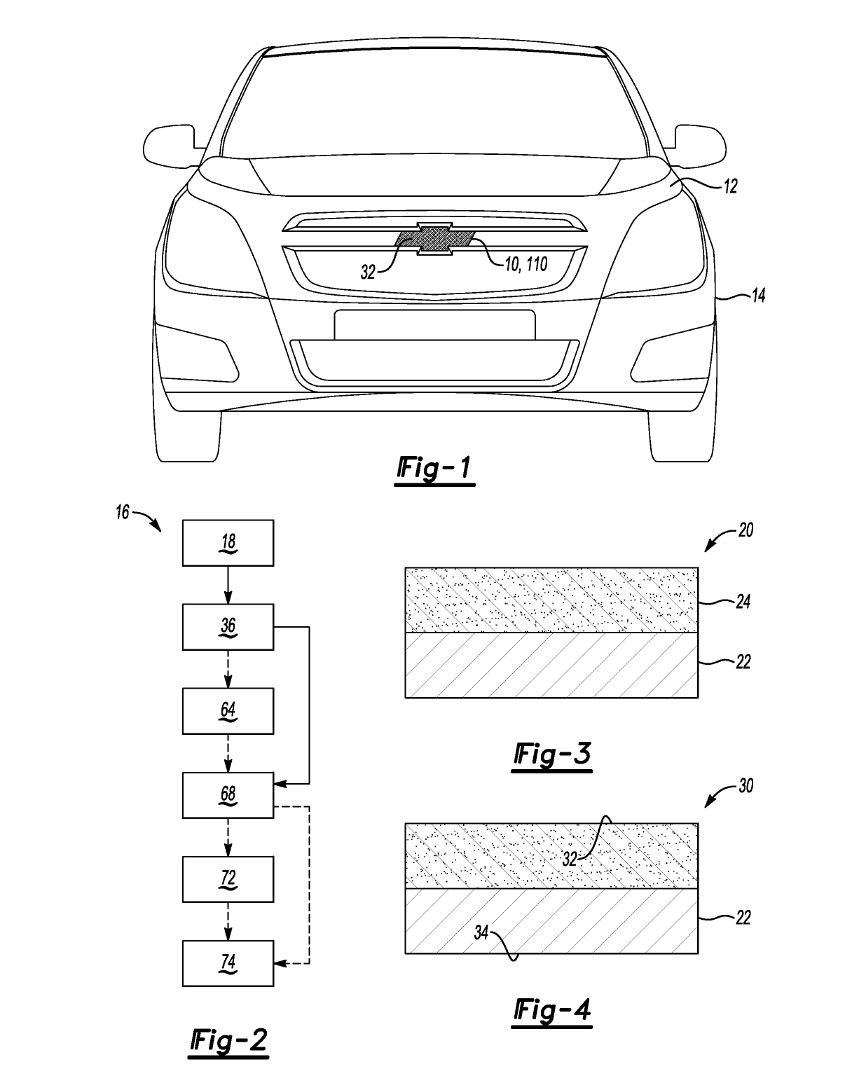

Referring to the Figures, wherein like reference numerals refer to like elements, an article 10 attachable to an exterior surface 12 of a vehicle 14 is shown generally in FIG. 1. For example, the article 10 may be an emblem 110 or badge configured for attachment to the exterior surface 12 of an automotive vehicle. In another example, although not shown, the article 10 may be a body side molding or rocker useful for attachment to the exterior surface 12 of the automotive vehicle. However, the article 10 may also be useful for non-automotive applications, such as, but not limited to, construction, rail, aviation, and marine vehicles.

Referring now to FIG. 2, a method 16 of forming the article 10 (FIG. 1) attachable to the exterior surface 12 (FIG. 1) of the vehicle 14 (FIG. 1) is disclosed. The method 16 includes heating (represented generally by block 18 of FIG. 2 and illustrated generally in FIG. 6) a thermoplastic system 20 (FIG. 3) to form a preform 30 (FIG. 4). As used herein, the terminology preform refers to a workpiece that undergoes subsequent processing, i.e., a work-in-process workpiece.

As described with reference to FIG. 3, the thermoplastic system 20 includes a substrate 22 and a cured film 24 formed from a coating composition and joined to the substrate 22. For example, the thermoplastic system 20 may be a laminated thermoplastic sheet formed by a thermoforming process. By way of non-limiting examples, the substrate 22 may be selected from the group including thermoplastic polyurethanes, polyesters, vinyl copolymers, polyvinylchlorides, thermoplastic olefin, acrylonitrile butadiene styrene, polyethylene, and blends, copolymers, and/or alloys thereof. Further, the cured film 24 may be formed from a coating composition such as, but not limited to, primer coating compositions, electrodeposition or e-coat coating compositions, basecoat coating compositions, and/or clearcoat coating compositions. That is, the cured film 24 may be a paint film, which may optionally include, for example, a primer layer (not shown), an e-coat layer (not shown), and a clearcoat layer (not shown). The cured film 24 may be chemically and/or physically joined to the substrate 22. For example, the cured film 24 may be chemically bonded to the substrate 22. Alternatively, the cured film 24 may be adhered to the substrate 22 by, for example, an adhesive layer (not shown) sandwiched between the cured film 24 and the substrate 22.

Referring now to FIG. 6, the thermoplastic system 20 may be heated in any suitable manner. For example, the thermoplastic system 20 may be loaded onto a frame (not shown) and translated into one or more heating stations (shown generally at 26 and 28 in FIG. 6). The heating stations 26, 28 may each increase a temperature of the thermoplastic system 20 to, for example, from about 135° C. to about 205° C. By way of a non-limiting example, the one or more heating stations 26, 28 may be characterized as quartz, calrod, ceramic, and/or halogen. Upon heating 18 (FIG. 2), the thermoplastic system 20 may be in a moldably softened state in preparation for forming the article 10 (FIG. 1).

As described with reference to FIG. 4, the preform 30 has a first surface 32 having an initial distinctness of image and an initial gloss. As used herein, the terminology distinctness of image refers to a characterization of the visual appearance of polished high-gloss surfaces. That is, distinctness of image indicates the sharpness of an image reflected by an object. More specifically, distinctness of image refers to a quantification of the deviation of light propagation from the regular direction by scattering during transmission or reflection. Distinctness of image may be measured in accordance with test method ASTM D5767-95 (2004). For the method 16 (FIG. 2), the first surface 32 may have an initial distinctness of image of greater than or equal to about 80 as measured in accordance with test method ASTM D5767-95 (2004).

Further, as used herein, the terminology gloss refers to a quantification of an ability of a surface, e.g., the first surface 32 (FIG. 4), to reflect light into the specular direction. That is, gloss is associated with the capacity of a surface to reflect more light in directions close to the specular direction than in other directions. As such, gloss is a measurement of the visual perception of objects, and is generally expressed in gloss units. For the method 16 (FIG. 2), the first surface 32 may have an initial gloss of greater than or equal to about 70 gloss units as measured in accordance with test method ASTM E40-11.

Accordingly, with continued reference to FIG. 4, the first surface 32 may have a class “A” surface finish. As used herein, the terminology class “A” refers to a surface finish that is suitable for a component forming or attached to the exterior surface 12 (FIG. 1) of the vehicle 14 (FIG. 1). That is, as compared to components suitable for forming or attachment to an interior surface (not shown) of the vehicle 14, a component having a class “A” surface finish has a surface having comparatively higher distinctness of image and gloss. Class “A” surfaces generally face an observer of the vehicle 14 who is positioned external to the vehicle 14.

Referring again to FIG. 4, the preform 30 has a second surface 34 spaced opposite from the first surface 32. That is, the second surface 34 represents an opposite side of the preform 30 from the first surface 32. Generally, the second surface 34 is configured for eventual attachment to the exterior surface 12 (FIG. 1) of the vehicle 14 (FIG. 1). Therefore, the first surface 32 may correspond to the cured film 24 (FIG. 3), and the second surface 34 may be attachable to the exterior surface 12 of the vehicle 14.

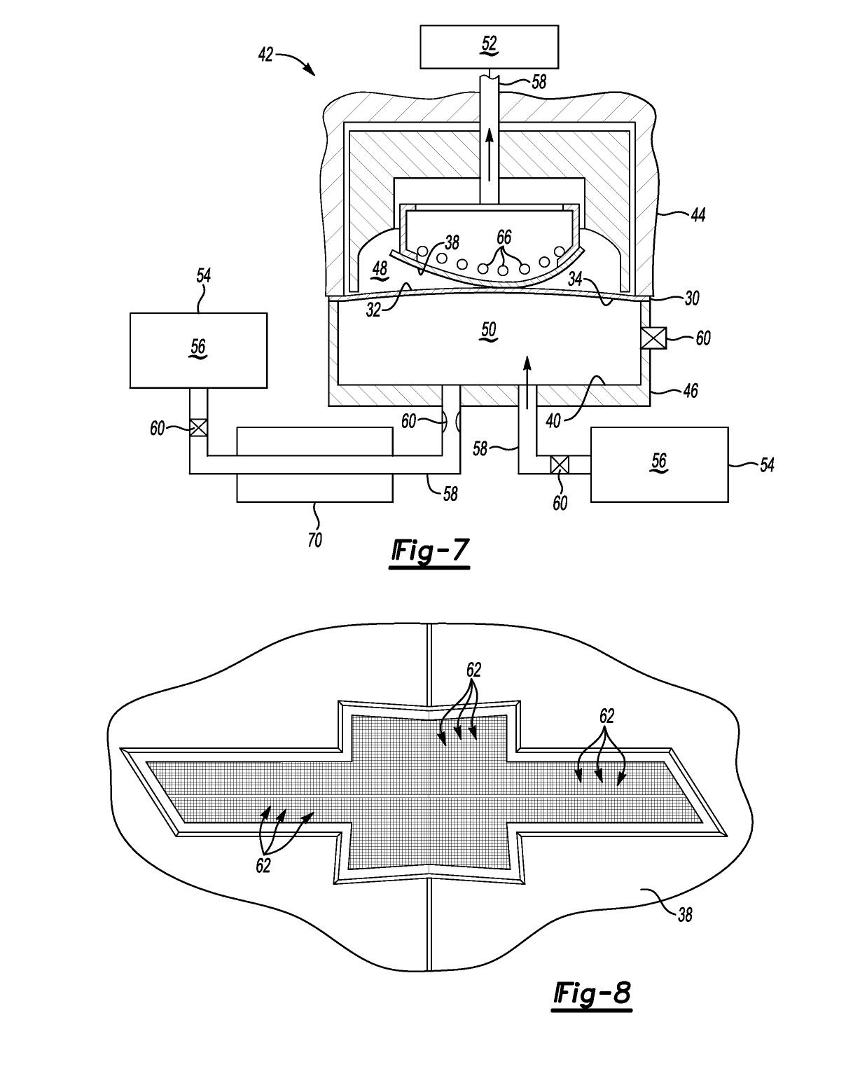

Referring now to FIGS. 2, 7, and 8, the method 16 (FIG. 2) also includes disposing 36 (FIG. 2) the preform 30 (FIGS. 7 and 8) between a mold surface 38 (FIGS. 7 and 8) and a pressure surface 40 (FIG. 7) spaced apart from the mold surface 38 so that the first surface 32 (FIGS. 7 and 8) faces the mold surface 38, and the second surface 34 (FIGS. 7 and 8) faces the pressure surface 40. That is, the first surface 32 is turned toward or oriented opposite from the mold surface 38, and the second surface 34 is turned toward or oriented opposite from the pressure surface 40.

As described with reference to FIG. 7, the mold surface 38 and the pressure surface 40 may be respective components of a device 42 configured for thermoforming the thermoplastic system 20 (FIG. 3). As used herein, the terminology thermoforming refers to a process of heating a thermoplastic material, e.g., the thermoplastic system 20, and shaping the thermoplastic material in a cavity defined by a mold. By way of non-limiting example, the device 42 may include two components that are separable from and sealable to one another. For example, as shown in FIG. 7, the device 42 may include a vacuum box component 44 and a pressure box component 46, wherein the vacuum box component 44 includes the mold surface 38, and the pressure box component 46 includes the pressure surface 40. Therefore, for the method 16 (FIG. 2), the preform 30 is oriented or disposed such that the first surface 32 thereof faces toward the vacuum box component 44, and the second surface 34 thereof faces toward the pressure box component 46.

With continued reference to FIG. 7, for the method 16 (FIG. 2), the first surface 32 and the mold surface 38 define a first cavity 48 therebetween. That is, the preform 30 may be disposed within the device 42 to seal off the vacuum box component 44 from the pressure box component 46 so as to define the first cavity 48 between the first surface 32 and the mold surface 38. Similarly, the second surface 34 and the pressure surface 40 define a second cavity 50 therebetween. That is, the preform 30 may be disposed within the device 42 to seal off the vacuum box component 44 from the pressure box component 46 so as to define the second cavity 50 between the second surface 34 and the pressure surface 40. That is, the first cavity 48 and the second cavity 50 are not disposed in fluid communication, but are rather separately sealed from one another.

In addition, although shown disposed adjacent one another in FIG. 7, the vacuum box component 44 and the pressure box component 46 may be movable toward and away from one another. For example, the vacuum box component 44 may be stationary and initially spaced apart from the pressure box component 46 so that the preform 30 may be loaded into the device 42 and disposed therebtween. Subsequently, after disposing 36 (FIG. 2) the preform 30 between the mold surface 38 and the pressure surface 40 as set forth above, the pressure box component 46 may translate toward the vacuum box component 44 until a closed, air-tight seal is defined between the vacuum box component 44 and the pressure box component 46.

As shown in FIG. 7, the vacuum box component 44 and first cavity 48 may be fluidly connected to a vacuum source 52, e.g., a pump configured for drawing down a vacuum within the first cavity 48. As used herein, the terminology vacuum refers to any pressure below atmospheric pressure. Similarly, the pressure box component 46 and second cavity 50 may be fluidly connected to a pressure source 54, e.g., a pump configured for pressurizing the second cavity 50 with a compressed gas 56. As used herein, the terminology compressed gas refers to gas having a pressure greater than atmospheric pressure. Suitable non-limiting examples of the compressed gas 56 include nitrogen and/or air. In addition, the device 42 may include one or more conduits 58 or valves 60 configured and arranged to convey fluid, e.g., the compressed gas 56 or air, to and from the vacuum source 52 and the pressure source 54.

In addition, referring to FIGS. 7 and 8, the mold surface 38 may have a predetermined shape according to a desired shape of the article 10 (FIG. 1). That is, as set forth in more detail below, the article 10 may be formed by shaping the first surface 32 to the mold surface 38. In one embodiment, as shown in FIG. 8, the mold surface 38 may define a plurality of recessions 62 therein. For example, each of the plurality of recessions 62 may be spaced apart from one another to define a pattern on the mold surface 38 such as, but not limited to, striping, cross-hatching, a checkerboard, a bevel, a diamond-shape, and the like, which may form a desired texture on the article 10.

Referring again to the method 16 as described with reference to FIG. 2, after disposing 36, in one embodiment, the method 16 may include cooling 64 the mold surface 38 (FIG. 7). For example, cooling 64 may reduce a temperature of the mold surface 38 to less than or equal to about 38° C. The mold surface 38 may be cooled in any manner. For example, as shown in FIG. 7, the device 42 may include a plurality of coolant lines 66 disposed adjacent the mold surface 38 through which a coolant or refrigerant, such as water, may flow to decrease the temperature of the mold surface 38. Such cooling 64 may contribute to the excellent distinctness of image and gloss of the formed article 10 (FIG. 1).

Referring now to FIGS. 2 and 7, the method 16 (FIG. 2) also includes, after disposing 36 (FIG. 2), conforming 68 (FIG. 2) the first surface 32 (FIG. 7) to the mold surface 38 (FIG. 7) to thereby form the article 10 (FIG. 1). That is, the first surface 32 may be molded to or pressed against the mold surface 38. For the embodiment including cooling 64 (FIG. 2) the mold surface 38, the method 16 includes conforming 68 after cooling 64. In one non-limiting example, conforming 68 may include concurrently evacuating the first cavity 48 (FIG. 7) and pressurizing the second cavity 50 (FIG. 7) to thereby dispose the first surface 32 in contact with the mold surface 38. That is, the first cavity 48 may be evacuated while the second cavity 50 is pressurized so that the first surface 32 is disposed adjacent and in contact with the mold surface 38.

More specifically, as described with reference to FIG. 7, evacuating may include exposing the first surface 32 to a vacuum of from about 33 KPa to about 75 KPa, e.g., from about 45 KPa to about 60 KPa, within the first cavity 48. Further, evacuating may expose the first surface 32 to the vacuum for a duration of from about 5 seconds to about 60 seconds. The vacuum source 52 may draw down a vacuum within the first cavity 48 so that the first surface 32 is pulled or sucked toward the mold surface 38 such that the first surface 32 contacts the mold surface 38 and conforms to the shape of the mold surface 38.

In addition, as also described with reference to FIG. 7, pressurizing may include applying a compressed gas (represented generally by 56 in FIG. 7) having a temperature of less than or equal to about 21° C. at a pressure of from about 345 KPa to about 1,035 KPa to the second surface 34. More specifically, pressurizing may include applying the compressed gas 56 having a temperature of from about 0° C. to about 16° C. at a pressure of from about 515 KPa to about 865 KPa to the second surface 34. Further, pressurizing may apply the compressed gas 56 to the second surface 34 for a duration of from about 5 seconds to about 40 seconds. To maintain the aforementioned temperature of the compressed gas 56 during pressurizing, the compressed gas 56 may pass through a chiller 70.

With continued reference to FIG. 7, the pressure source 54 may apply a pressure to the second surface 34 within the second cavity 50 so that the second surface 34 is pushed or pressed toward the mold surface 38 such that the first surface 32 contacts the mold surface 38 and conforms to the shape of the mold surface 38. That is, concurrently evacuating the first cavity 48 and pressurizing the second cavity 50 may mold the preform 30 so that the first surface 32 conforms to the shape of the mold surface 38. Stated differently, the pressure of the compressed gas 56 from the pressure source 54 may press against the second surface 34 of the preform 30 to thereby dispose the first surface 32 onto the mold surface 38, while the vacuum drawn by the vacuum source 52 draws the first surface 32 onto the mold surface 38.

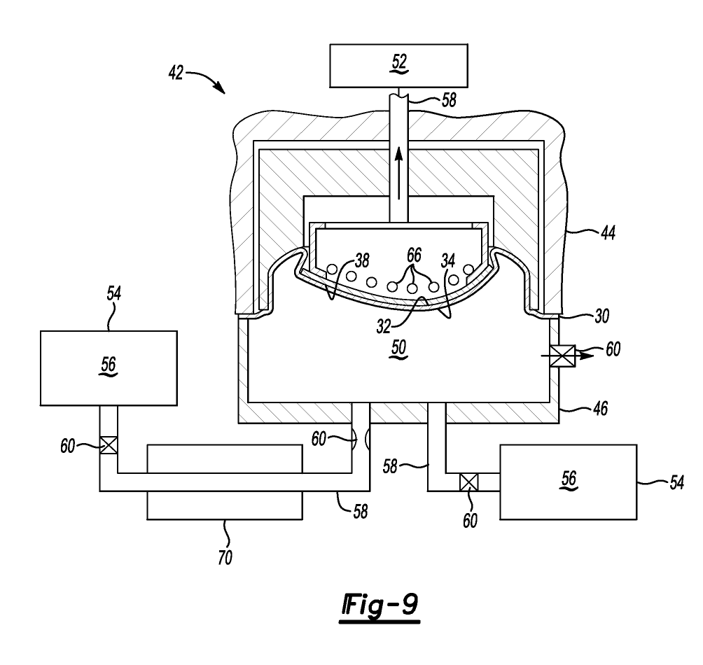

Further, referring now to FIG. 9, after disposing 36 (FIG. 2), the method 16 (FIG. 2) may also include flushing 72 (FIG. 2) the second cavity 50 with the compressed gas 56 having a temperature of from about 0° C. to about 21° C. for a duration of from about 1 second to about 15 seconds, e.g., for from about 5 seconds to about 10 seconds. That is, the compressed gas 56 may pass through the chiller 70 and flush the second cavity 50 of the pressure box component 46 at a pressure of from about 515 KPa to about 865 KPa. Flushing 72 the second cavity 50 may advantageously chill the preform 30, e.g., the first surface 32, to a temperature of less than or equal to about 95° C. Ideally, the temperature of the first surface 32 is reduced to less than or equal to about 88° C. within 30 seconds, e.g., within 15 seconds, of conforming 68 (FIG. 2) the first surface 32 to the mold surface 38.

Referring again to FIG. 2, after cooling 64 and/or optional flushing 72, the method 16 may include removing 74 the formed article 10 (FIG. 1) from the device 42 (FIG. 9). That is, the method 16 may include separating the vacuum box component 44 (FIG. 9) and the pressure box component 46 (FIG. 9) so that the formed article 10 (FIG. 1) may be released from the mold surface 38 (FIG. 9). In addition, depending upon the desired shape of the formed article 10, the formed article 10 may be further cooled and/or trimmed to size.

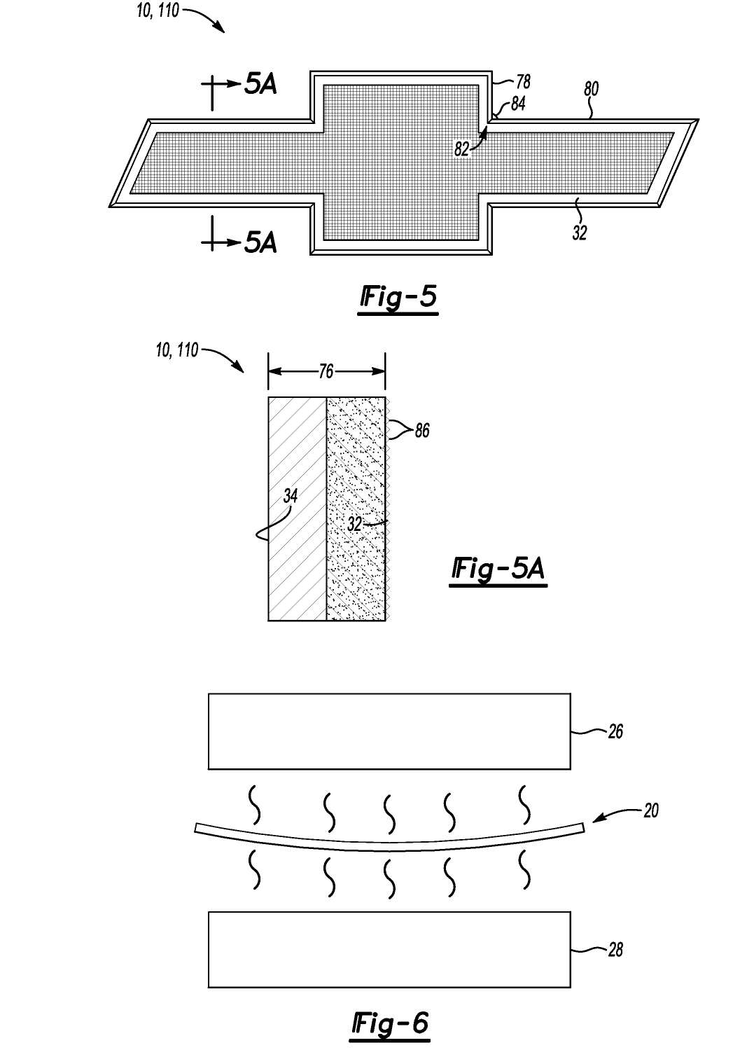

Referring again to the Figures, the article 10 (FIGS. 1 and 5) formed by conforming 68 (FIG. 2) the first surface 32 (FIGS. 7 and 9) to the mold surface 38 (FIGS. 7 and 9) as set forth above has the initial distinctness of image and the initial gloss. That is, the initial distinctness of image and initial gloss of the first surface 32 of the preform 30 (FIG. 4) does not substantially change during the method 16 (FIG. 2) so that the formed article 10 also has the initial distinctness of image and the initial gloss. In particular, conforming 68 the first surface 32 to the mold surface 38 may preserve the initial distinctness of image and the initial gloss. Stated differently, the article 10 maintains the initial distinctness of image and the initial gloss. As such, the article 10 has the class “A” surface finish, and is suitable for attachment to the exterior surface 12 (FIG. 1) of the vehicle 14 (FIG. 1). That is, the initial distinctness of image of the article 10 may be greater than or equal to about 80 as measured in accordance with test method ASTM D5767-95 (2004), and the initial gloss may be greater than or equal to about 70 gloss units as measured in accordance with test method ASTM E40-11. Stated differently, the article 10 has both excellent distinctness of image and gloss, and is therefore suitable for attachment to the exterior surface 12 of the vehicle 14. Without intending to be limited by theory, conforming 68 the first surface 32, rather than the second surface 34, to the mold surface 38 may contribute to such excellent distinctness of image and gloss. Further, cooling 64 (FIG. 2) the mold surface 38 may also contribute to the excellent distinctness of image and gloss.

In addition, as best shown in FIG. 5A, the article 10 may have a thickness 76 of from about 1.5 mm to about 2.5 mm, e.g., from about 1.7 mm to about 2.3 mm. That is, the article 10 may be characterized as a thick-film thermoform. If desired, the article 10 may also include a mask layer (not shown) removably disposed on the article 10 and configured for protecting the article 10 before the article 10 is attached to the exterior surface 12 (FIG. 1) of the vehicle 14 (FIG. 1). Moreover, referring again to FIG. 5, the article 10 may have a first leg 78 and a second leg 80 adjoining the first leg 78 to define a junction 82 therebetween having a radius of curvature 84 of from about 0.3 mm to about 0.7 mm. For example, the junction 82 may have a radius of curvature 84 of about 0.5 mm. Advantageously, the aforementioned radius of curvature 84 is achievable without a reduction in initial distinctness of image and/or initial gloss, and without de-lamination of the article 10. As such, the method 16 (FIG. 2) is useful for applications requiring articles 10 having intricate designs, such as lettering, numerals, and comparatively sharp corners or junctions 82.

Referring again to FIG. 5A, for the embodiment of the mold surface 38 (FIG. 8) defining the plurality of recessions 62 (FIG. 8) therein, the resulting article 10 formed by the method 16 (FIG. 2) includes a plurality of protrusions 86 thereon each corresponding to a respective one of the plurality of recessions 62. That is, the formed article 10 may have a textured appearance. It is to be appreciated that such textured appearance is achievable since the method 16 includes conforming 68 (FIG. 2) the first surface 32, rather than the second surface 34, to the mold surface 38.

As such, the aforementioned method 16 forms articles 10 having a class “A” surface and optional excellent definition of texture. In addition, the method 16 allows for formation of a minimized radius of curvature 84, e.g., about 0.5 mm. Further, the method 16 economically produces articles 10 within desired production cycle times, and provides articles 10 having excellent durability that are suitable for attachment to the exterior surface 12 of the vehicle 14. As such, the method 16 allows for economical and efficient formation of the article 10, and the article 10 contributes to an increased perceived quality of the vehicle 14.

While the best modes for carrying out the disclosure have been described in detail, those familiar with the art to which this disclosure relates will recognize various alternative designs and embodiments for practicing the disclosure within the scope of the appended claims.

1. A method of forming an article attachable to an exterior surface of a vehicle, the method comprising:
heating a thermoplastic system to form a preform, wherein the thermoplastic system includes;
a substrate; and
a cured film formed from a coating composition and joined to the substrate; and
wherein the preform has;
a first surface having an initial distinctness of image and an initial gloss; and
a second surface spaced opposite from the first surface;
disposing the preform between a mold surface and a pressure surface spaced apart from the mold surface so that the first surface faces the mold surface and the second surface faces the pressure surface;
wherein the first surface and the mold surface define a first cavity therebetween, and wherein the second surface and the pressure surface define a second cavity therebetween; and
after disposing, conforming the first surface to the mold surface to thereby form the article, wherein the article has the initial distinctness of image and the initial gloss.

2. The method of claim 1, wherein conforming includes concurrently evacuating the first cavity and pressurizing the second cavity to thereby dispose the first surface in contact with the mold surface.

3. The method of claim 2, wherein conforming preserves the initial distinctness of image and the initial gloss.

4. The method of claim 2, wherein pressurizing includes applying a compressed gas having a temperature of less than or equal to about 21° C. at a pressure of from about 345 KPa to about 1,035 KPa to the second surface.

5. The method of claim 4, wherein pressurizing includes applying the compressed gas having a temperature of from about 0° C. to about 16° C. at a pressure of from about 515 KPa to about 865 KPa to the second surface.

6. The method of claim 4, wherein pressurizing applies the compressed gas to the second surface for a duration of from about 5 seconds to about 40 seconds.

7. The method of claim 2, wherein evacuating includes exposing the first surface to a vacuum of from about 33 KPa to about 75 KPa within the first cavity.

8. The method of claim 7, wherein evacuating exposes the first surface to the vacuum for a duration of from about 5 seconds to about 60 seconds.

9. The method of claim 1, further including, after disposing, cooling the mold surface to a temperature of less than or equal to about 38° C.

10. The method of claim 1, wherein the article has a thickness of from about 1.5 mm to about 2.5 mm.

11. The method of claim 1, wherein the article has a first leg and a second leg adjoining the first leg to define a junction therebetween having a radius of curvature of from about 0.3 mm to about 0.7 mm.

12. The method of claim 1, wherein the initial distinctness of image is greater than or equal to about 80 as measured in accordance with test method ASTM D5767-95(2004).

13. The method of claim 1, wherein the initial gloss is greater than or equal to about 70 gloss units as measured in accordance with test method ASTM E40-11.

14. The method of claim 1, further including, after disposing, flushing the second cavity with a compressed gas having a temperature of from about 0° C. to about 21° C. for a duration of from about 1 second to about 15 seconds.

15. The method of claim 1, wherein the article is an emblem configured for attachment to the exterior surface of the vehicle.

16. A method of forming an article attachable to an exterior surface of a vehicle, the method comprising:
heating a thermoplastic system to form a preform, wherein the thermoplastic system includes;
a substrate; and
a cured film formed from a coating composition and joined to the substrate; and
wherein the preform has;
a first surface corresponding to the cured film and having an initial distinctness of image and an initial gloss; and
a second surface spaced opposite from the first surface;
disposing the preform between a mold surface and a pressure surface spaced apart from the mold surface so that the first surface faces the mold surface and the second surface faces the pressure surface;
wherein the mold surface defines a plurality of recessions therein;
wherein the first surface and the mold surface define a first cavity therebetween, and wherein the second surface and the pressure surface define a second cavity therebetween so that the first cavity and the second cavity are not disposed in fluid communication;
after disposing, cooling the mold surface; and
after cooling, concurrently evacuating the first cavity and pressurizing the second cavity to conform the first surface to the mold surface and thereby form the article;
wherein the article has the initial distinctness of image and the initial gloss and includes a plurality of protrusions thereon each corresponding to a respective one of the plurality of recessions.

17. The method of claim 16, wherein the article has a first leg and a second leg adjoining the first leg to define a junction therebetween having a radius of curvature of from about 0.3 mm to about 0.7 mm.

18. A method of forming an article attachable to an exterior surface of a vehicle, the method comprising:
heating a thermoplastic system to form a preform, wherein the thermoplastic system includes;
a substrate; and
a cured film formed from a coating composition and joined to the substrate; and
wherein the preform has;
a first surface corresponding to the cured film and having an initial distinctness of image and an initial gloss; and
a second surface spaced opposite from the first surface;
disposing the preform between a mold surface and a pressure surface spaced apart from the mold surface so that the first surface faces the mold surface and the second surface faces the pressure surface;
wherein the first surface and the mold surface define a first cavity therebetween, and wherein the second surface and the pressure surface define a second cavity therebetween;
after disposing, cooling the mold surface to a temperature of less than or equal to about 38° C.; and
after cooling, conforming the first surface to the mold surface to thereby dispose the first surface in contact with the mold surface and form the article;
wherein conforming includes concurrently evacuating the first cavity and pressurizing the second cavity;
wherein evacuating includes exposing the first surface to a vacuum of from about 33 KPa to about 75 KPa within the first cavity for a duration of from about 5 seconds to about 60 seconds; and
wherein pressurizing includes applying a compressed gas having a temperature of less than or equal to about 21° C. at a pressure of from about 345 KPa to about 1,035 KPa to the second surface for a duration of from about 5 seconds to about 40 seconds;
wherein the article has the initial distinctness of image and the initial gloss.

19. The method of claim 18, wherein the initial distinctness of image is greater than or equal to about 80 as measured in accordance with test method ASTM D5767-95 (2004) and the initial gloss is greater than or equal to about 70 gloss units as measured in accordance with test method ASTM E40-11.

20. The method of claim 19, wherein the mold surface defines a plurality of recessions therein, and further wherein the article includes a plurality of protrusions thereon each corresponding to a respective one of the plurality of recessions.
